(19) United States
(12) Patent Application Publication
(10) Pub. No.: US 2007/0204587 A1
(43) Pub. Date: Sep. 6, 2007

(54) Specialty crop knockdown shield for rotary platforms

(76) Inventors: Allan Wesley Rosenbalm, Blakesburg, IA (US); Philip Alan Harden, Bloomfield, IA (US); Wendell Wayne Manning, Brownsville, OR (US); Duane Wallace Huppert, Ellensburg, WA (US)

Correspondence Address: DEERE & COMPANY, ONE JOHN DEERE PLACE, MOLINE, IL, 61265, US

(21) Appl. No.: 11/366,036

(22) Filed: Mar. 2, 2006

(51) Int. Cl. A01D 45/02

(52) U.S. Cl. 56/119

(57) ABSTRACT

A crop knockdown shield is provided for use with rotary platforms in harvesting specialty crops such as grass seed. The knockdown shield is mounted to the front of the platform and extends forwardly and upwardly at an angle ahead of the cutting device. The knockdown shield can comprise two panels hingedly attached to one another so as to allow one panel to be folded back in shorter crops to improve visibility and to provide an extension of the first panel in higher crops. The knockdown shield serves to gently lean the crop forward before cutting so as to minimize seed shatter due whipping of the seed head.

### FIELD OF THE INVENTION

The present invention relates generally to devices for harvesting crops. More particularly, the present invention relates to rotary platforms for cutting specialty crops such as grass seed. Specifically, the present invention relates to a crop knockdown shield for use with such rotary platforms when harvesting such specialty crops.

### BACKGROUND OF THE INVENTION

In the commercial grass seed business it is current practice to harvest grass seed, after the seed has reached maturity, by first cutting and windrowing the crop with a sickle auger or sickle draper platform on a self-propelled windrower. The grass stems are then allowed to dry prior to combining. Such platfroms typically converge and form a windrow with the aid of augers and rod type fingers. These platforms are operated without the conditioning elements and are capable of field operations of 4 to 6 MPH. Rotary platforms on the other hand are capable of over 10 MPH ground speed in the same conditions. However, rotary platforms have not traditionally been accepted for grass seed applications because of high grain loss. Part of the reason for high grain loss is due to the front shields and curtains typically found on rotary platforms. While the conventional shields and curtains work well for normal hay applications they do not work well for specialty crops such as grass seed. More particularly, when rotary platforms are used in grass seed crops the faster ground speed causes the seed heads to whip and shatter seed. However, sickle auger type platforms have higher than desired seed loss from the reel function and auger convergence. Likewise, draper platforms have problems in some conditions forming acceptable windrows. Further, the knife cutting system of sickle type platforms limits cutting speed and productivity in the tough grass conditions, and typically requires changing knives twice a year or more to maintain efficient cutting components, at a significant annual expense. Because the grass seed is susceptible to shatter losses once the crop matures, timely harvest is critical to minimize losses. Accordingly there is a clear need in the art for improvements that would allow the use of rotary platforms so as to increase productivity, reduce crop losses, and reduce maintenance expenses as desired in grass seed applications.

### SUMMARY OF THE INVENTION

In view of the foregoing, it is an object of the invention to provide improvements to rotary harvesting platforms so as to allow them to be used in specialty crop applications such as grass seed.

Another object of the invention is the provision of a crop knockdown shield that allows crop to be more gently leaned forward before cutting to reduce seed loss.

A further object of the invention is to provide such a shield that is compatible with known harvesting techniques.

An additional object of the invention is the provision of such a shield that retains visibility for the operator in short crops while allowing for use in taller crops.

The foregoing and other objects of the invention together with the advantages thereof over the known art which will become apparent from the detailed specification which follows are attained by a crop knockdown shield for a crop cutting machine having a crop cutting device, the knockdown shield extending angularly forward and upward from the crop cutting machine ahead of the crop cutting device.

Other objects of the invention are attained by an improved platform for cutting crops, the platform having at least one crop cutting device, the improvement comprising: a crop knockdown shield extending angularly forward and upward from the platform ahead of the crop cutting device.

In general, a crop knockdown shield is provided for use with rotary platforms in harvesting specialty crops such as grass seed. The knockdown shield is mounted to the front of the platform and extends forwardly and upwardly at an angle ahead of the cutting device. The knockdown shield can comprise two panels hingedly attached to one another so as to allow one panel to be folded back in shorter crops to improve visibility and to provide an extension of the first panel in higher crops. The knockdown shield serves to gently lean the crop forward before cutting so as to minimize seed shatter due whipping of the seed head.

By adding a shield to the front of the cutting unit the seed plant can be gently leaned forward in preparation to be cut. The shield extends forward and upward so that the seed head will not whip over the top and cause seed shatter. When cutting shorter crops the shield does not need to have a lot of height so the shield is hinged at a lower area of the shield so as to lower the shield for better visibility. The advantage to adding this type of shield to a rotary platform is that the customer can benefit from the faster ground speed and less seed loss. This means less fuel needed to cut crop and potentially fewer machines required. It has been proven that the rotary platforms equipped with the present invention have less seed loss than sickle type platforms and can operate in wetter conditions.

To acquaint persons skilled in the art most closely related to the present invention, one preferred embodiment of the invention that illustrates the best mode now contemplated for putting the invention into practice is described herein by and with reference to, the annexed drawings that form a part of the specification. The exemplary embodiment is described in detail without attempting to show all of the various forms and modifications in which the invention might be embodied. As such, the embodiment shown and described herein is illustrative, and as will become apparent to those skilled in the art, can be modified in numerous ways within the spirit and scope of the invention—the invention being measured by the appended claims and not by the details of the specification.

### BRIEF DESCRIPTION OF THE DRAWINGS

For a complete understanding of the objects, techniques, and structure of the invention reference should be made to the following detailed description and accompanying drawings, wherein:

FIG. 1 is a top view of a rotary platform equipped with the knockdown shield according to the invention; and,

FIG. 2 is a partially cut-away side view of the platform of FIG. 1.

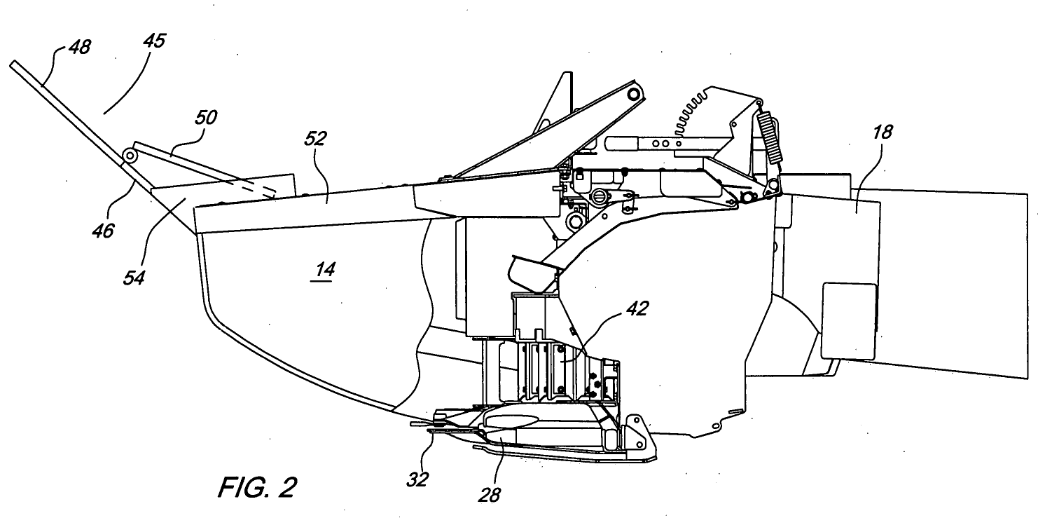

### DESCRIPTION OF THE PREFERRED EMBODIMENT

With reference now to the drawings it can be seen that a rotary platform is designated generally by the numeral 10. As shown the rotary platform 10 includes a body defined by right- and left-hand sidewalls 12 and 14, respectively. Right- and left-hand upright transverse walls or bulkheads (not visible), respectively, extend inwardly from the sidewalls 12 and 14 and terminate at forward ends of right- and left-hand, fore-and-aft extending inner sidewalls 16 and 18 that define a crop passage 20 located centrally between the sidewalls 12 and 14.

An elongate rotary cutterbar 22 extends transversely between the sidewalls 12 and 14. Extending the length of and defining a rear portion of the cutterbar 22 is a tubular stiffener beam 24 of square cross section that is bolted to lower portions of the lower vertical sections, respectively of the transverse walls.

A plurality of cutting units 26 and 28 respectively include cutter discs 30 and 32. The inner sidewalls 16 and 18 are respectively spaced inwardly from the opposite sides of the header 10 between the cutting units 26C and 26D on the one side and between 28C and 28D on the other side. Each cutting unit 26 and includes rotary cutting discs 30 and 32 respectively. A different relationship between these cutter discs and the sidewalls would be required for cutterbars having more or less cutting units, but the resulting structure would not depart from the principles of the invention.

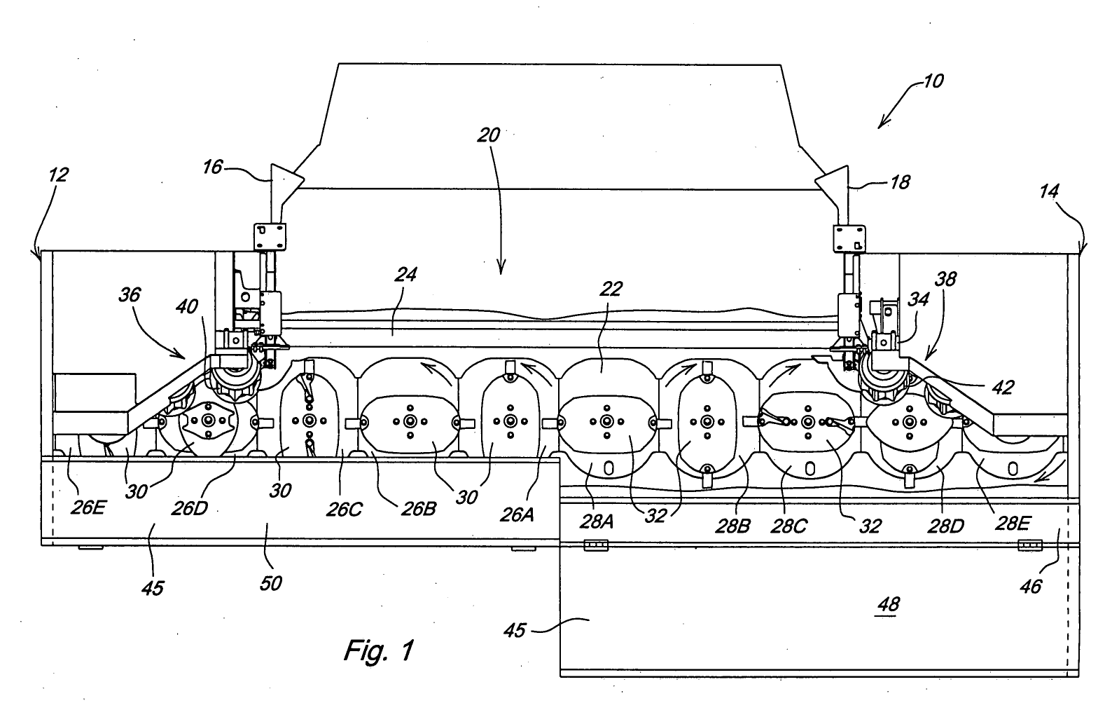

A main power distributing gear box (not shown) is mounted directly above the cutter disc 32 of the left-hand end cutting unit 28E. The gearing contained in the gear box and cutterbar 22 is arranged such that, as viewed from above in FIG. 1, the left-hand cutter discs 32, are rotated in a clockwise direction while the right-hand cutter discs 30 are rotated in a counterclockwise direction, the respective directions being indicated by arrows. The particular directions of rotation tend to move cut crop toward the crop passage 20.

The movement of crop to the crop passage 20 is enhanced by right- and left-hand convergence structures 36 and 38, respectively, including ribbed drums 40 and 42, respectively. It is noted that in lieu of the drums 40 and 42, cage structures, each defined by ribs extending vertically between upper and lower cylindrical discs, could be used.

A crop knockdown shield according to the invention is designated by the numeral 45. As shown the knockdown shield 45 comprises three sections, a lower panel 46, an upper left hand panel 48, and an upper right hand panel 50. The lower panel 46 is angularly mounted to a top sheet 52 of the platform 10 and to the sidewalls 12 and 14 by way of brackets 54. The lower panel 46 thus extends forwardly from the platform 10 at an approximate angle preferably in the range of 25-60 degrees. As can be seen the upper right and left hand panels 50 and 48, respectively, are hingedly mounted to the lower panel 46 by way of hinges 56, so that the upper panels 50 and 48 can be folded relative to the lower panel 46. For purposes of illustration in the Figures the upper left hand panel 48 is shown hinged forward so as to extend forwardly at the same 25-60 degree angle as the lower panel 46, while the upper right hand panel 50 is hinged rearward over the lower panel 46. It is, however, contemplated that either both upper panels 50 and 48 would be hinged forwardly during field operations or both upper panels would be hinged rearwardly during transport operations or in field operations in short crops. It is further contemplated that means could be provided for securing the upper panels in the forward or rearward position. It is also within the scope of the present invention to replace the separate upper panels 50 and 48 with a single upper panel that is hinged to the lower panel 46. Similarly it is contemplated that the knockdown shield 45 could comprise a unitary panel that could be rigidly or hingedly affixed to the platform 10.

In operation in taller crops both upper panels 50 and 48 are hinged forwardly so to provide an extension of the lower panel 46. In operation in shorter crops or during transport operations both upper panels 50 and 48 can be hinged rearwardly over the lower panel 46 so as to provide the operator with improved visibility. The knockdown shield 45 thus extends in front of the cutting unit and serves to gently lean forward the seed plant in preparation to be cut. Because the shield 45 extends forwardly and upwardly the seed head does not whip over the top of the shield or platform, thereby reducing seed shatter. An advantage of providing the shield 45 to a rotary platform is that the operator can benefit from the faster ground speed and less seed loss. Less fuel is therefore needed to cut crop and potentially fewer machines are required.

Thus it can be seen that the objects of the invention have been satisfied by the structure presented above. While in accordance with the patent statutes, only the best mode and preferred embodiment of the invention has been presented and described in detail, it is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly and legally entitled.

The embodiments of the invention in which an exclusive property or privilege is claimed are defined as follows:

1. A crop knockdown shield for a crop cutting machine having a crop cutting device, the knockdown shield extending angularly forward and upward from the crop cutting machine ahead of the crop cutting device.

2. A crop knockdown shield for a crop cutting machine as set forth in claim 1 wherein the knockdown shield comprises at least one panel extending angularly upward and forward from the crop cutting machine.

3. A crop knockdown shield for a crop cutting machine as set forth in claim 1 wherein the knockdown shield comprises at least one first panel and at least one second panel, the at least one second panel being movably attached to the at least one first panel.

4. A crop knockdown shield for a crop cutting machine as set forth in claim 1 wherein the knockdown shield comprises a first panel rigidly affixed to the crop cutting machine and at least one second panel hingedly mounted to the first panel.

5. A crop knockdown shield for a crop cutting machine as set forth in claim 4 wherein the at least one second panel is movable from a first position where the at least one second panel provides an extension of the first panel, to a second position where the at least one second panel lays rearwardly over the first panel.

6. A crop knockdown shield for a crop cutting machine as set forth in claim 1 wherein the knockdown shield extends forwardly and upwardly at an 25-60 degree angle relative to the cutting device.

7. A crop knockdown shield for a crop cutting machine as set forth in claim 2 wherein the at least one panel extends forwardly and upwardly at an 25-60 degree angle relative to the cutting device.

8. A crop knockdown shield for a crop cutting machine as set forth in claim 5 wherein the first panel and the at least one second panel, when in the first position, extend forwardly and upwardly at an 25-60 degree angle relative to the cutting device.

9. An improved platform for cutting crops, the platform having at least one crop cutting device, the improvement comprising:
a crop knockdown shield extending angularly forward and upward from the platform ahead of the crop cutting device.

10. An improved platform for cutting crops as set forth in claim 9 wherein the knockdown shield comprises at least one panel extending angularly upward and forward from the crop cutting machine.

11. An improved platform for cutting crops as set forth in claim 9 wherein the knockdown shield comprises at least one first panel and at least one second panel, the at least one second panel being movably attached to the at least one first panel.

12. An improved platform for cutting crops as set forth in claim 9 wherein the knockdown shield comprises a first panel rigidly affixed to the crop cutting machine and at least one second panel hingedly mounted to the first panel.

13. An improved platform for cutting crops as set forth in claim 12 wherein the at least one second panel is movable from a first position where the at least one second panel provides an extension of the first panel, to a second position where the at least one second panel lays rearwardly over the first panel.

14. An improved platform for cutting crops as set forth in claim 9 wherein the knockdown shield extends forwardly and upwardly at an 25-60 degree angle relative to the cutting device.

15. An improved platform for cutting crops as set forth in claim 10 wherein the at least one panel extends forwardly and upwardly at an 25-60 degree angle relative to the cutting device.

16. An improved platform for cutting crops as set forth in claim 13 wherein the first panel and the at least one second panel, when in the first position, extend forwardly and upwardly at an 25-60 degree angle relative to the cutting device.
